(19) United States
(12) Patent Application Publication
(10) Pub. No.: US 2018/0273761 A1
(43) Pub. Date: Sep. 27, 2018

(54) PIGMENT DISPERSANT, AQUEOUS PIGMENT DISPERSION COMPOSITION, AND AQUEOUS INK

(71) Applicant: FUJI XEROX CO., LTD., Tokyo (JP)

(72) Inventors: Kosaku YOSHIMURA, Minamiashigara-shi (JP); Tomohiro SHINYA, Minamiashigara-shi (JP)

(73) Assignee: FUJI XEROX CO., LTD., Tokyo (JP)

(21) Appl. No.: 15/808,068

(22) Filed: Nov. 9, 2017

(30) Foreign Application Priority Data
Mar. 24, 2017 (JP) 2017-058951
Mar. 24, 2017 (JP) 2017-058952

(51) Int. Cl. C09B 67/46; C08F 290/04; C09D 11/037; C09D 11/322

(52) U.S. Cl. CPC C09B 67/009; C09D 11/322; C09D 11/037; C08F 290/044

(57) ABSTRACT

A pigment dispersant includes: a polymer having a structural unit represented by General Formula (1); and a structural unit derived from a polystyrene macromonomer.

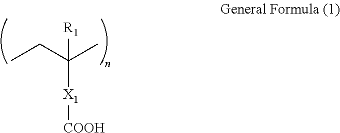

In General Formula (1), n represents a positive integer, R₁ represents a hydrogen atom or a methyl group, and X₁ represents a divalent linking group except a single bond.

### CROSS REFERENCE TO RELATED APPLICATIONS

This application is based on and claims priority under 35 USC 119 from Japanese Patent Application No. 2017-058951 fled on Mar. 24, 2017 and Japanese Patent Application No. 2017-058952 fled on Mar. 24, 2017.

### BACKGROUND

### Technical Field

The present invention relates to a pigment dispersant, an aqueous pigment dispersion composition, and an aqueous ink.

### SUMMARY

According to an aspect of the invention, there is provided a pigment dispersant including a polymer having a structural unit represented by General Formula (1) and a structural unit derived from a polystyrene macromonomer.

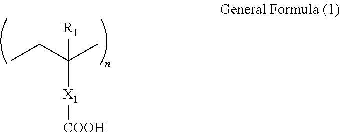

In General Formula (1), n represents a positive integer, R₁ represents a hydrogen atom or a methyl group, and X₁ represents a divalent linking group except a single bond.

### BRIEF DESCRIPTION OF THE DRAWINGS

Exemplary embodiment(s) of the present invention will be described in detail based on the following FIGURES, wherein:

FIG. 1 is a schematic diagram illustrating a recording apparatus according to the exemplary embodiment.

### DETAILED DESCRIPTION

Hereinafter, detailed description of an exemplary embodiment according to the present invention will be provided.

<Pigment Dispersant>

A pigment dispersant according to the exemplary embodiment includes a polymer having a structural unit represented by General Formula (1) and a structural unit derived from a polystyrene macromonomer. The pigment dispersion according to the exemplary embodiment may include another structural unit other than the structural unit represented by General Formula (1) and the structural unit derived from a polystyrene macromonomer.

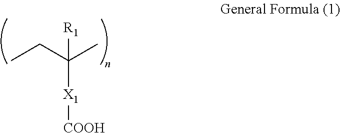

In General Formula (1), n represents a positive integer, R₁ represents a hydrogen atom or a methyl group, and X₁ represents a divalent linking group except a single bond.

The pigment dispersant according to the exemplary embodiment includes a structural unit derived from a polystyrene macromonomer and is thus easily adsorbed onto the surface of a pigment. It is considered that this enhances the function of the pigment dispersant in an aqueous medium including an organic solvent.

Further, the pigment dispersant according to the exemplary embodiment includes a structural unit represented by General Formula (1). In the structural unit represented by General Formula (1), a carboxy group is bonded to the main chain skeleton of a copolymer through X₁ that is a divalent linking group. By being bonded to the main chain skeleton of a copolymer through a divalent linking group, a neutralized carboxy group is likely to have a pKa value in neutral or weakly alkaline region which is suitable for pigment storage stability in an aqueous medium including an organic solvent in neutral or weakly alkaline region compared to the pKa value of the neutralized carboxy group in a structural unit derived from acrylic acid or methacrylic acid. It is considered that this improves the pigment storage stability improves in neutral or weakly alkaline region.

From the above reasons, it is inferred that the pigment dispersant according to the exemplary embodiment has excellent pigment storage stability in an aqueous medium including an organic solvent in neutral or weakly alkaline region compared to the copolymer having a structural unit derived from a methacrylic acid or acrylic acid.

Hereinafter, detailed description of the pigment dispersant according to the exemplary embodiment will be provided.

—Structural Unit represented by General Formula (1)—

The structural unit represented by General Formula (1) is not particularly limited so long as the structural unit is a structural unit in which a divalent linking group is interposed between a carboxy group and the main chain skeleton of a copolymer.

The expression “a divalent linking group is interposed between a carboxy group and the main chain skeleton of a copolymer”, i.e., implies that the monomer from which the structural unit represented by General Formula (1) is derived is neither acrylic acid nor methacrylic acid.

Examples of the divalent linking group represented by X₁ include: a linear, branched, or cyclic alkylene group; an aralkylene group; an arylene group; a heterocyclic group; —CO—; —O—; —NH—; —S—; and combinations thereof.

The number of atoms interposed between a carbon atom bonded to R₁ of General Formula (1) and a carboxy group may be 1 to 16, and the atom may be at least one selected from the group consisting of a carbon atom, an oxygen atom, a nitrogen atom, a sulfur atom, a silicon atom, and a phosphorous atom.

The number of atoms interposed between the carbon atom bonded to R₁ and the carboxy group is preferably 1 to 12, and more preferably 1 to 8.

The number of atoms interposed between the carbon atom bonded to R₁ and the carboxy group is equivalent to the distance based on the number of atoms between the carboxylic group and the main chain skeleton of the copolymer. This means that the carboxy group is distanced away from the main chain skeleton of a copolymer as the number of atoms increases.

In a case where X₁ includes a cyclic structure such as an aromatic ring and an alicyclic alkyl group, the minimal number of atoms interposed between the carbon atom bonded to R₁ and the carboxy group is counted as the number of atoms interposed between the carbon atom bonded to R₁ and the carboxy group.

Although specific examples of X₁ are shown below, X₁ is not limited to the following specific examples. In the following specific examples, the spot marked with * is where X₁ is bonded to the carbon atom bonded to R₁, and the spot marked with ** is where X₁ is bonded to a carboxy acid. The number marked in the following specific examples indicates the number of atoms interposed between the carbon atom bonded to R₁ and the carboxy acid in each of the specific examples.

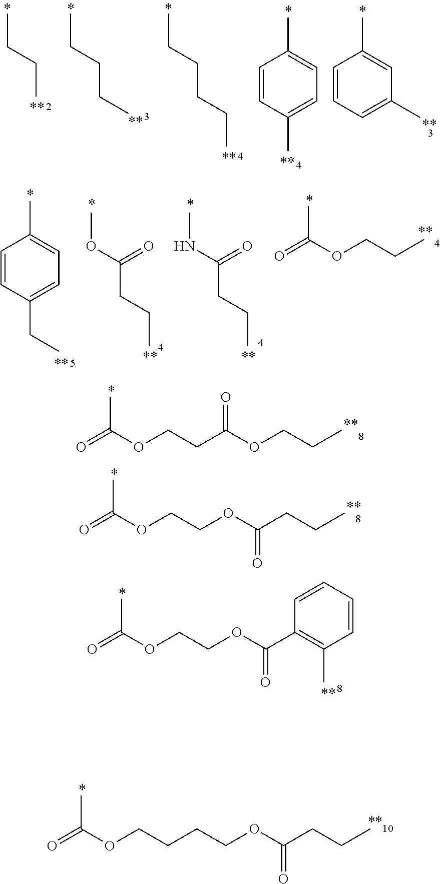

The structural unit represented by General Formula (1) may be a structural unit derived from a (meth)acrylate compound.

Examples of a methacrylate compound from which the structural unit represented by General Formula (1) include 2-(meth)acryloyloxyethyl hexahydrophthalic acid, 2-(meth)acryloyloxyethyl succinic acid, 2-(meth)acryloyloxyethyl phthalic acid, and β-carboxyethyl acrylate. These compounds may be used singly or two or more kinds thereof may be used in combination.

In the exemplary embodiment, the term “(meth)acrylate” means “acrylate” or “methacrylate”, “(meth)acryloyloxy” means “acryloyloxy” or “(meth)acryloyloxy”, “(meth)acrylic acid” means “acrylic acid” or “methacrylic acid”, and “(meth)acryloyl group” means “acryloyl group” or “methacryloyl group”.

The structural unit represented by General Formula (1) may be a structural unit derived from a (meth)acrylic acid multimer. The (meth)acrylic acid multimer is represented by General Formula (2).

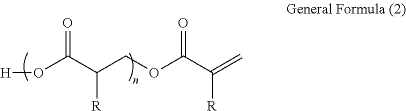

In General Formula (2), R represents a hydrogen atom or a methyl group, n represents an integer, n is preferably 1 to 4, and more preferably 1 to 3. In a case where R is a hydrogen atom and n is 1, the structural unit is β-carboxyethyl acrylate.

The structural unit represented by General Formula (1) may be one that is formed by adding an acid anhydride to a hydroxyl group bonded to, directly or through a divalent linking group, a main chain skeleton of a polymer.

Specific examples of the acid anhydride added to a hydroxyl group include succinic anhydride, phthalic anhydride, 3-methylphthalic anhydride, trimellitic anhydride, maleic anhydride, itaconic anhydride, citraconic anhydride, methyl-5-norbornene-2,3-dicarboxylicanhydride, 3,4,5,6-tetrahydrophthalic anhydride, and cis-1,2,3,6-tetrahydrophthalic anhydride. These compounds may be used singly or two or more kinds thereof may be used in combination.

—Structural Unit Derived from Polystyrene Macromonomer—

The polystyrene macromonomer from which the structural unit derived from a polystyrene macromonomer is derived is preferably a copolymer of a styrene having a polymerizable double bond at one terminal end only, or a copolymer of the styrene and another monomer. Examples of the polystyrene macromonomer include an oligomer formed of a polystyrene having one molecular terminal end to which a (meth)acryloyl group is bonded. Examples of the other monomer include acrylonitrile.

The percentage of the structural unit derived from styrene in a polystyrene macromonomer in terms of mass is preferably 95% by weight or more.

The number-average molecular weight of the polystyrene macromonomer is not particularly limited, but preferably 1,000 to 10,000, more preferably 2,000 to 9,000, and even more preferably 3,000 to 8,000.

Specific examples of the polystyrene macromonomer are a polystyrene oligomer methacryloylated on one terminal end (Mn=6,000, product name: AS-6, manufactured by Toagosei Co., Ltd.) and a polystyrene acrylonitrile oligomer methacryloylated on one terminal end (Mn=6,000, product name: AS-6S, manufactured by Toagosei Co., Ltd.).

The polystyrene macromonomer may be used singly, two or more kinds thereof may be used in combination.

The pigment dispersant according to the exemplary embodiment may be a polymer having a structural unit having an aromatic group from the main chain skeleton with a linking group interposed therebetween, and having an acid value of 30 mgKOH/g to 100 mgKOH/g instead of the structural unit derived from a polystyrene macromonomer. The polymer may include a structural unit derived from a polystyrene macromonomer, may include another structural unit other than the structural unit represented by General Formula (1) and the structural unit having an aromatic group from the main chain skeleton with a linking group interposed therebetween.

—Structural Unit Having Aromatic Group with Linking Group Interposed Therebetween—

The structural unit having an aromatic group from the main chain skeleton with a linking group interposed therebetween is not limited to a particular structure and may be a structural unit represented by General Formula (3), for example.

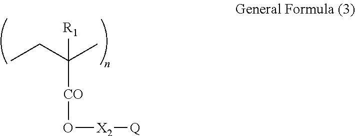

In General Formula (3), n represents a positive integer, R₁ represents a hydrogen atom or a methyl group, X₂ represents a divalent linking group that is not a single bond and does not include an aromatic ring, and Q represents an aromatic group that may have a substituent.

The structure in parentheses of General Formula (3) corresponds to the main chain skeleton and —CO—O—X₂ corresponds to a linking group.

Examples of the divalent linking group excluding an aromatic ring structure represented by X₂ include an alkylene group, an oxyalkylene group, an alkynylene group, a cycloalkylene group, and an imino group.

Specific examples of the alkylene group include a methylene group, an ethylene group, a propylene group, a butylene group, a pentylene group, a hexylene group, a heptylene group, an octylene group, a decylene group, and a tetradecylene group, and an octadecylene group.

Specific examples of the oxyalkylene group include an oxymethylene group, an oxyethylene group, an oxypropylene group, and an oxybutylene group.

Specific examples of the alkynylene group include an ethynylene group and a propynylene group.

Specific examples of the cycloalkylene group include a cyclohexylene group and a cyclopentylene group.

X₂ is preferably a methylene group or an oxyethylene group from the viewpoint of dispersion stability.

The aromatic group that may have a substituent represented by Q may be an aryl group, for example. The number of carbon atom of an aryl group is preferably 6 to 30, and more preferably 6 to 20.

Specific examples of the aryl group include a phenyl group, an α-naphthyl group, and a β-naphthyl group.

Examples of the substituent include an alkyl group, a halogen atom (e.g., fluorine atom, chloride atom, and bromide atom), a hydroxy group, and an aryl group

The number of atoms interposed between a carbon atom bonded to R₁ and an aromatic group in General Formula (3) is 2 to 20, and the atom may be at least one selected from the group consisting of a carbon atom, an oxygen atom, a nitrogen atom, a sulfur atom, a silicon atom, and a phosphorous atom.

The number of atoms interposed is preferably 2 to 12.

The number of atoms interposed between the carbon atom and a carboxylic group is equivalent to the distance based on the number of atoms between the aromatic group and the main chain skeleton of the polymer. This means that the aromatic group is distanced away from the main chain skeleton of a polymer as the number of atoms increases.

In a case where X₂ includes a cyclic structure such as an alicyclic alkyl group, the minimal number of atoms is counted as the number of atoms by which X₂ and R₁ are able to be connected interposed between a carbon atom bonded to R₁ and the aromatic group.

The structural unit having an aromatic group from the main chain skeleton with a linking group interposed therebetween may be a structural unit derived from a (meth)acrylic ester having an aromatic group.

Specific examples of the (meth)acrylic ester having an aromatic group include benzyl acrylate, benzyl methacrylate, phenoxyethyl methacrylate, and phenoxyethyl acrylate.

In the pigment dispersant according to the exemplary embodiment, the percentage of the aromatic ring in the entire polymer is preferably from 15% by weight to 36% by weight, and more preferably from 20% by weight to 32% by weight.

In a case where the content of the aromatic ring is 15% by weight or more, a decrease of absorptivity of the pigment dispersant to a pigment may be suppressed and thus dispersion stability in the low pH region improves. On the other hand, in a case where the content of the aromatic ring is 36% by weight or less, an excessive increase of absorptivity of the pigment dispersant to a pigment may be suppressed, by which the steric repulsive force of the pigment dispersant hardly decreases, and thus the decrease of dispersion stability is likely to be suppressed.

Herein, the term “the percentage of the aromatic ring” means the total content of “a monocyclic aromatic ring and a condensed ring formed by condensing monocyclic aromatic rings” included in a polymer. In calculation of the content of the aromatic ring in a polymer, substituents substituted at the monocyclic aromatic ring and the condensed ring formed by condensing monocyclic aromatic rings are excluded.

That is, the percentage of the aromatic ring is calculated from the percentage, to the molecular weight of the structural unit represented by General Formula (1), the structural unit having an aromatic group from the main chain skeleton with a linking group interposed therebetween and the other structural group derived from a monomer used as necessary, of the molecular weight of the aromatic ring (except an aromatic ring that is a substituent, in a case where the structural unit has a substituent) included in the structural unit (mass %).

The other monomer from which the other structural unit that may be included in the pigment dispersant according to the exemplary embodiment is derived is not limited to a particular monomer.

Examples of the other monomer include α, β-ethylenically unsaturated carboxylic acid ester compounds such as (meth) acrylic acid esters, itaconic acid esters, fumaric acid esters, and maleic acid esters; vinyl ester compounds such as vinyl acetate; vinyl cyanide compounds such as acrylonitrile; acrylamide compounds such as acrylamide; aromatic vinyl compounds such as styrene, alkyl-substituted styrene, halogen-substituted styrene and vinylnaphthalene; halogen-substituted ethylene compounds such as vinyl chloride and vinylidene chloride; ethylenically unsaturated compounds such as ethylene, propylene, butene, butadiene, isoprene, cyclopentadiene, and pinen. These compounds may be used singly or two or more kinds thereof may be used in combination.

Among these compounds, from the viewpoints of ease of polymerization and further suppressing the decrease of the storage stability of the pigment dispersion in which a pigment is dispersed, a compound having a (meth) acryloyl skeleton is preferable such as a (meth) acrylic esther: for example, methyl (meth)acrylate, ethyl (meth)acrylate, n-butyl (meth)acrylate, 2-ethylhexyl (meth)acrylate, octyl (meth)acrylate, 2-hydroxyethyl (meth)acrylate, and 2-hydroxypropyl (meth)acrylate.

The percentage of the structural unit represented by General Formula (1) included in the pigment dispersant according to the present invention, the structural unit derived from a polystyrene macromonomer, and the other structural unit used as necessary is as follows.

The percentage of the structural unit derived from a polystyrene macromonomer in the pigment dispersant according to the exemplary embodiment in the entire polymer is preferably from 10% by weight to 80% by weight, more preferably from 15% by weight to 60% by weight, and even more preferably from 20% by weight to 50% by weight.

In a case where the percentage of the structural unit derived from a polystyrene macromonomer is 10% by weight or more, adsorptivity of the pigment dispersant to a pigment may improve, and thus dispersion stability of the pigment may improve in a case where an organic solvent is impregnated in an aqueous medium. In a case where the percentage of the structural unit derived from a polystyrene macro monomer is 80% by weight or less, a decrease of the hydrophilicity of a pigment to which the pigment dispersant is attached may be suppressed and thus dispersion stability in the low pH region of the pigment improves.

The percentage of the structural represented by General Formula (1) in the pigment dispersant according to the exemplary embodiment in the entire polymer is preferably from 5% by weight to 50% by weight, more preferably from 5% by weight to 45% by weight, and even more preferably from 5% by weight to 40% by weight.

The percentage in the structural unit represented by General Formula (1) may be set, as appropriate, considering the acid value of the pigment dispersant that will be described below.

The ratio of the structural unit represented by General Formula (1) and the structural unit derived from a polystyrene macromonomer included in the pigment dispersant according to the exemplary embodiment in terms of mass (structural unit represented by General Formula (1): structural unit derived from polystyrene macromonomer) is preferably 15:85 to 60:40, more preferably 20:80 to 50:50, and even more preferably 25:75 to 50:50.

The ratio of the structural unit represented by General Formula (1) included in a polymer, the structural unit having an aromatic group from the main chain skeleton with a linking group interposed therebetween, and the other structural unit used as necessary is as follows.

The percentage of the structural unit having an aromatic group from the main chain skeleton with a linking group interposed therebetween in the entire polymer is preferably from 20% by weight to 85% by weight, more preferably from 35% by weight to 80% by weight, and even more preferably from 45% by weight to 74% by weight.

The percentage of the structural unit represented by General Formula (1) in the entire polymer is preferably from 5% by weight to 30% by weight, more preferably from 7% by weight to 30% by weight, and even more preferably from 10% by weight to 28% by weight.

The percentage in the structural unit represented by General Formula (1) may be set, as appropriate, considering the acid value of the pigment dispersant that will be described below.

In a case where the pigment dispersant according to the exemplary embodiment has the other structural unit, the percentage of the other structural unit in the entire amount of the pigment dispersant according to the exemplary embodiment is preferably more than 0% by weight and 70% by weight or less, more preferably from 5% by weight to 60% by weight, and even more preferably from 10% by weight to 50% by weight.

The acid value of the pigment dispersant according to the exemplary embodiment is preferably from 30 mgKOH/g to 250 mgKOH/g. In a case where the acid value of the pigment dispersant is 30 mgKOH/g or more, the pigment dispersion stability may improve, and sediment of the pigment and an increase of the viscosity of the pigment dispersant are not likely to be caused. In a case where the acid value of the pigment dispersant is 250 mgKOH/g or less, deterioration of the dispersion stability of the pigment may be prevented, and a decrease of the water resistance or alkali resistance of the image is suppressed. The acid value of the pigment dispersant is more preferably from 35 mgKOH/g to 150 mgKOH/g, and even more preferably from 40 mgKOH/g to 100 mgKOH/g.

The measurement of the acid value is carried out according to JIS K0070:1992 using a neutralization titration method. That is, an appropriate amount of a sample of the pigment dispersant is collected, and 100 mL of a solvent (tetrahydrofuran) and a few drops of an indicator (phenolphthalein solution) are added thereto, the solution is shaked thoroughly in a water bath until the sample is completely dissolved. This solution is titrated with 0.1 mol/l of potassium hydroxide ethanol solution, and the end point is set to the point when the light red color of the indicator has lasted 30 seconds. When the acid value is set to A, the sample amount to S (g), 0.1 mol/l potassium hydroxide ethanol solution used for titration to B (ml), and f is set to a factor of 0.1 mol/l potassium hydroxide ethanol solution, the acid value A is calculated from the expression A=(B×f×5.611)/S

The weight-average molecular weight of the pigment dispersant according to the exemplary embodiment is not particularly limited. The weight-average molecular weight of the pigment dispersant is preferably from 8,000 to 300,000. In a case where the weight-average molecular weight of the pigment dispersant is 8,000 or more, deterioration of the pigment dispersion stability is likely to be suppressed, and sediment of the pigment and an increase of the viscosity of the pigment dispersion are unlikely to be caused. In a case where the weight-average molecular weight of the pigment dispersant is 300,000 or less, the viscosity of the pigment dispersion is unlikely to be increased, and dispersion failure of the pigment hardly occurs and dispersion time is likely to be prolonged. The weight-average molecular weight of the pigment dispersant is more preferably from 10,000 to 150,000, even more preferably from 10,000 to 100,000, and particularly preferably from 10,000 to 80,000.

The weight-average molecular weight (Mw) and the number-average molecular weight (Mn) are a value measured by gel permeation chromatography (GPC). Specifically, the molecular weight measurement by GPC is carried out with THF as the solvent using a “HLC-8120 GPC” as a measuring apparatus manufactured by Tosoh Corporation and a column⋅TSKgel SuperHM-M (15 cm) manufactured by Tosoh Corporation. The weight-average molecular weight and the number-average molecular weight are calculated from this measurement result using a molecular weight calibration curve prepared from a monodisperse polystyrene standard sample.

Next, a method for producing the pigment dispersant according to the exemplary embodiment.

The pigment dispersant according to the exemplary embodiment is obtained by, for example, polymerizing by radical polymerization using monomers of radical polymerizable compounds such as a monomer from which the structural unit represented by General Formula (1) is originated, a polystyrene macromonomer and/or a monomer from which the structural unit having an aromatic group from the main chain skeleton with a linking group interposed therebetween is derived, and other monomers used as necessary other than these monomers.

Specifically, polymerization methods such as a solution polymerization, an emulsion polymerization, and a suspension polymerization may be employed. For example, in a solution polymerization method, a solvent which homogeneously dissolves reagents such as a monomer and a radical polymerization initiator is usually used. Examples of the solvent include an aliphatic hydrocarbon, an aromatic hydrocarbon, a halogenated hydrocarbon, an alcohol, a carboxylic acid, a nitrile, an ester, a ketone, a sulfoxide, and water. Examples of those solvents include: as the aliphatic hydrocarbon, hexane and cyclohexane; as the aromatic hydrocarbon, toluene and xylene; as the halogenated hydrocarbon, chloroform and carbon tetrachloride; as the alcohol ethanol, isopropyl alcohol, ethylene glycol, propylene glycol, 1,4-butanediol, diethylene glycol, and dipropylene glycol; as the carboxylic acid, acetic acid, and propionic acid; as the nitrile, acetonitrile; as the ester, ethyl acetate and butyl acetate; as the ketone, methyl ethyl ketone, methyl isobutyl ketone; and, as the sulfoxide, dimethyl sulfoxide.

In a case where polymerization is performed by radical polymerization using a monomer of radical polymerizable compounds, a polymerization initiator may be used. Examples of the polymerization initiator include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethyl benzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, pertriphenylacetic acid, tert-butyl hydroperoxide, tert-butyl formate, tert-butyl peracetate, tert-butyl perbenzoate, tert-butyl perphenylacetate, tert-butyl permethoxyacetate, tert-butyl excess N-(3-toluyl) carbamate, ammonium bisulfate, and sodium bisulfate; azo compounds such as 2,2′-azobis (isobutyronitrile) (MEW), 2,2′-azobis-(2,4′-dimethylvaleronitrile), and dimethyl-2,2′-azobis(2-methylpropionate).

From the viewpoint of adjusting the molecular weight of the pigment dispersant, a chain transfer agent may also be used. Examples of the chain transfer agent include compounds having thiol sites such as hexylthiol, heptanethiol, octanethiol, nonane thiol, decanethiol, dodecanethiol, tetradecanethiol, and hexadecanethiol.

The pigment dispersant according to the exemplary embodiment may be applied to any of the cases where the pigment dispersion in which a pigment has been dispersed is either oily (non-aqueous) or aqueous. In particular, in a case where the pigment dispersant according to the exemplary embodiment is applied as the pigment dispersant in a case where the pigment dispersion in which a pigment is dispersed is aqueous, a decrease of storage stability of the aqueous pigment dispersion is further suppressed.

The aqueous pigment dispersion in which a pigment is dispersed using the pigment dispersant according to the exemplary embodiment may be applied, for example, as a pigment dispersion of an aqueous paint or a pigment dispersion of an aqueous ink.

In the pigment dispersant according to the exemplary embodiment, the structure of the structural unit in the polymer and abundance thereof can be identified through measurement with analytical instruments for nuclear magnetic resonance (NMR), pyrolysis gas chromatograph mass spectrometry (GC-MS), and the like.

(Aqueous Pigment Dispersion Composition)

The aqueous pigment dispersion composition according to the exemplary embodiment includes a pigment dispersant according to the exemplary embodiment, a pigment, and water. The composition further includes a water-soluble organic solvent.

The pigment dispersant included in the aqueous pigment dispersion composition may be used in combination of the pigment dispersant according to the exemplary embodiment and another pigment dispersant other than the pigment dispersant according to the exemplary embodiment. Examples of the other pigment dispersant other than the pigment dispersant according to the exemplary embodiment include a polymer pigment dispersant according to the exemplary embodiment, an anionic surfactant, a cationic surfactant, an amphoteric surfactant, and a nonionic surfactant.

From the viewpoint of further suppressing a decrease of the storage stability of the pigment dispersant, the pigment dispersant according to the exemplary embodiment included in an aqueous pigment dispersion composition is preferably 90% by weight or more, and preferably 100% by weight with respect to the entire amount of the pigment dispersant included in an aqueous pigment dispersion composition.

Although the content of the pigment dispersant according to the exemplary embodiment differs depending on the kind of the pigment and is thus not particularly limited, the content is preferably, for example, from 0.1% by weight to 100% by weight with respect to the pigment in an aqueous pigment dispersion composition.

The following is a description regarding the pigment.

Although the pigment is not limited to a particular pigment, organic pigments and inorganic pigments can be mentioned as examples thereof.

Specific examples of a black pigment include Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, and Raven 1060 (all manufactured by Columbian Carbon Corporation); Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (all manufactured by Cabot Corporation); and Color Black FW1, Color Black FW2, Color Black FW2V, Color Black 18, Color Black FW200, Color Black 5150, Color Black S160, Color Black S170, Printex 35, Printex U, Printex V, Printex 140U, Printex 140V, Special Black 6, Special Black 5, Special Black 4A, and Special Black 4 (all manufactured by Orion Engineered Carbons, Inc.); No. 25, No. 33, No. 40, No. 47, No. 52, No. 900, No. 2300, MCF-88, MA600, MA7, MA8, and MA100 (all manufactured by Mitsubishi Chemical Corporation), but not limited to these pigments.

Specific examples of a cyan pigment include C.I. Pigment Blue-1, -2, -3, -15, -15: 1, -15: 2, -15: 3, -15: 4, -16, -22, and -60, but not limited to these pigments.

Specific examples of a magenta color pigment include C.I. Pigment Red-5, -7, -12, -48, -48: 1, -57, -112, -122, -123, -146, -168, -177, -184, -202, and C.I. Pigment Violet-19, but not limited to these pigments.

Specific examples of the yellow pigment include C.I. Pigment Yellow-1, -2, -3, -12, -13, -14, -16, -17, -73, -74, -75, -83, -93, -95, -97, -98, -114, -128, -129, -138, -151, -154, and -180, but not limited to these pigments.

Further, examples of the pigments other than black and three primary color pigments of cyan, magenta and yellow include specific color pigments such as red, green, blue, brown, and white; Metallic lustrous pigments such as gold and silver; colorless or light color extender pigments; and plastic pigments.

Examples of the pigments also include particles obtained by fixing a dye or a pigment to the surface of silica, alumina, polymer bead or the like that are the core, insoluble laked products of dyes, colored emulsions, and colored latexes.

In some cases, dispersing a quinacridone pigment (for example, CI Pigment Red-122) in an aqueous medium is difficult, but the use of the pigment dispersant according to the exemplary embodiment allows the quinacridone pigment to be stably dispersed in an aqueous medium.

The content of the pigment in an aqueous pigment dispersion composition is not particularly limited, so long as the amount included therein is predetermined. The content thereof is, for example, from 1% by weight to 30% by weight (preferably from 2% by weight to 25% by weight) with respect to the entire amount of the aqueous pigment dispersion composition.

The following is a description regarding the water.

From the viewpoint of preventing contamination from impurities or generation of microorganisms in particular, preferable examples of the water include, ion exchanged water, ultrapure water, distilled water, and ultrafiltration water.

The amount of the water included in an aqueous pigment dispersion composition is not particularly limited, so long as the amount is determined such that a predetermined concentration of the pigment included in the pigment dispersion composition can be obtained.

The following is a description regarding the water-soluble organic solvent. For example, the water-soluble organic solvent is used on the purposes of suppressing drying at the time of storage of an aqueous pigment dispersion composition and enhancing film formability at the time of drying of the coating using an aqueous pigment dispersion composition.

Examples of the water-soluble organic solvent include polyhydric alcohols, polyhydric alcohol derivatives, nitrogen-containing solvents, alcohols, and sulfur-containing solvents. Examples of the water-soluble organic solvent other than these include propylene carbonate and ethylene carbonate.

Examples of polyhydric alcohols include sugar alcohols such as ethylene glycol, diethylene glycol, propylene glycol, dipropylene glycol, butylene glycol, triethylene glycol, 1,5-pentanediol, 1,2-hexanediol, 1,2,6-hexanetriol, glycerin, trimethylolpropane, and xylitol; saccharides such as xylose, glucose, and galactose.

Examples of polyhydric alcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, dipropylene glycol monomethyl ether, dipropylene glycol monobutyl ether, and ethylene oxide adduct of diglycerin.

Examples of the nitrogen-containing solvent include pyrrolidone, N-methyl-2-pyrrolidone, cyclohexylpyrrolidone, and triethanolamine.

Examples of alcohols include ethanol, isopropyl alcohol, butyl alcohol, and benzyl alcohol.

Examples of the sulfur-containing solvents include thiodiethanol, thiodiglycerol, sulfolane, and dimethylsulfoxide.

The water-soluble organic solvent may be used singly or two or more kinds thereof may also be used in combination.

The amount of the water-soluble organic solvent is not particularly limited, so long as the amount is determined such that a predetermined concentration of the pigment included in the pigment dispersion composition can be obtained corresponding to the degrees of suppressing drying at the time of storage of an aqueous pigment dispersion composition and enhancing film formability at the time of drying of the coating using an aqueous pigment dispersion composition. The content of the water-soluble organic solvent may be from 1% by weight to 60% by weight, for example, and preferably from 1% by weight to 40% by weight.

The aqueous pigment dispersion composition may include other additives as necessary. Examples of the other additives include an antioxidant, an antifungal agent, a conductive agent, an ultraviolet absorber, and a chelating agent.

The viscosity of the aqueous pigment dispersion composition differs depending on the kind of the pigment and not particularly limited. The viscosity of the aqueous pigment dispersion composition is, for example, in a viscosity range of 1.5 mPa·s to 30 mPa·s, preferably 1.5 mPa·s to 20 mPa·s.

From the viewpoint of further suppressing a decrease of the storage stability of the aqueous pigment dispersion composition, the viscosity difference between the viscosity immediately after preparation (before storage) of the aqueous pigment dispersion composition and that after storage (for example, after storage at 80° C. for 6 days) is preferably from 0 mPa·s to 1.0 mPa·s, more preferably from 0 mPa·s to 0.5 mPa·s.

The viscosity is measured in a viscosity measurement mode using a viscoelasticity measuring apparatus (model number: MARS, manufactured by HAAKE) as a measuring device, using a cone plate having a diameter of 35 mm at a measurement temperature of 23° C. and a shear rate of 100 rpm.

From the viewpoint of further suppressing a decrease of the storage stability of the aqueous pigment dispersion composition, the volume-average particle diameter of the pigment dispersed in the aqueous pigment dispersion composition difference between the volume-average particle diameter immediately after preparation (before storage) of the aqueous pigment dispersion composition and that of after storage (for example, after storage at 80° C. for 6 days) is preferably from 0 nm to 10 nm, more preferably 0 nm to 5 nm.

As a method for measuring the volume average particle diameter, measurement is carried out using a dynamic light scattering type particle diameter distribution measuring apparatus (LB-500, manufactured by Horiba Ltd.) at 25° C.

Applications of the aqueous pigment dispersion composition are not particularly limited, but applications such as aqueous paint and aqueous ink for various printing can be mentioned.

(Aqueous Ink)

Next, the following is a description regarding the aqueous ink.

The aqueous ink (hereinafter, also referred to simply as “ink”) includes the pigment dispersant, the pigment, the water, and the water-soluble organic solvent according to the exemplary embodiment.

The aqueous ink includes the pigment dispersant according to the exemplary embodiment. The pigment dispersant included in the aqueous ink may be used in combination of the pigment dispersant according to the exemplary embodiment and another pigment dispersant other than the pigment dispersant according to the exemplary embodiment. The other pigment dispersant other than the pigment dispersant according to the exemplary embodiment is not limited to a particular pigment, but the same pigment dispersants as the pigment dispersants other than the pigment dispersant according to the exemplary embodiment included in the above-described aqueous pigment dispersion composition can be mentioned as examples thereof.

From the viewpoint of further suppressing a decrease of the storage stability of the aqueous ink, the pigment dispersant according to the exemplary embodiment included in the aqueous ink is preferably 90% by weight or more, and more preferably 100% by weight with respect to the entire amount of the pigment dispersant included in an aqueous ink.

Although the content of the pigment dispersant according to the exemplary embodiment differs depending on the dispersibility of the pigment and is thus not particularly limited, the content is preferably, for example, from 0.1% by weight to 100% by weight with respect to the pigment in the aqueous ink.

Although the pigment is not limited to a particular pigment, the same organic pigments and inorganic pigments as the pigment included in the above-described aqueous pigment dispersion composition can be mentioned as examples thereof. Examples thereof include a black pigment, a cyan pigment, a magenta pigment and a yellow pigment, and specific examples of these pigments include pigments included in the above-described aqueous pigment dispersion composition.

The content of the pigment included in the aqueous ink is, for example, preferably from 1% by weight to 25% by weight, and more preferably from 2% by weight to 20% by weight with respect to the entire amount of the aqueous ink.

From the viewpoint of preventing contamination from impurities or generation of microorganisms in particular, preferable examples of the water include, ion exchanged water, ultrapure water, distilled water, and ultrafiltration water.

The content of the water is, for example, preferably from 10% by weight to 95% by weight, more preferably from 30% by weight to 90% by weight with respect to the entire amount of the aqueous ink.

As the water-soluble organic solvent, the same organic solvents as the water-soluble organic solvent included in the above-described aqueous pigment dispersion composition can be mentioned as examples thereof. Examples of the water-soluble organic solvent include polyhydric alcohols, polyhydric alcohol derivatives, nitrogen-containing solvents, alcohols, sulfur-containing solvents, propylene carbonate and ethylene carbonate, and specific examples of these water-soluble organic solvent include the same solvents as those water-soluble organic solvent included in the above-described aqueous pigment dispersion composition.

The content of the water-soluble organic solvent is preferably from 1% by weight to 60% by weight, and more preferably from 1% by weight to 40% by weight.

The following is a description regarding the other additives.

The aqueous ink may include other additives. Examples of the other additives include an ink ejection property improving agent (polyethylene imine, polyamines, polyvinyl pyrrolidone, polyethylene glycol, ethyl cellulose, carboxymethyl cellulose, and the like), a conductivity/pH regulator (compounds of alkali metals such as potassium hydroxide, sodium hydroxide, and lithium hydroxide), a reactive diluent solvent, a penetrant, a pH buffer, an antioxidant, an antifungal agent, a viscosity modifier, a conductive agent, a chelating agent, an ultraviolet absorber, an infrared absorber, and the like.

Examples of the other additives include a surfactant for facilitating adjustment of the surface tension of aqueous ink. Examples of the surfactant include known surfactants such as surfactants having HLB (hydrophilic group/hydrophobic group balance “Hydrophile-Lipophile Barance”) of 14 or less. Examples of using the surfactant having HLB of 14 or less include a method using a surfactant having HLB of 14 or less singly or using a plurality kinds of surfactants having different HLBs in combination to adjust HLB to 14 or less.

HLB (hydrophilic group/hydrophobic group balance “Hydrophile-Lipophile Barance”) is a value defined by the following formula (Griffin method). HLB=20×(total molecular weight of hydrophilic portion/molecular weight)

The pH of the aqueous ink is, for example, preferably in a range of 4 to 10 (more preferably 7.5 to 9.5).

The conductivity of the aqueous ink is, for example, preferably in a range of 0.01 S/m to 0.5 S/m, more preferably 0.01 S/m to 0.25 S/m, and even more preferably 0.01 S/m to 0.20 S/m.

The viscosity of the aqueous ink is, for example, in a range of 1.5 mPa·s to 30 mPa·s, preferably 1.5 mPa·s to 20 mPa·s.

From the viewpoint of further suppressing a decrease of the storage stability of the aqueous ink, the viscosity difference between the viscosity immediately after preparation (before storage) of the aqueous ink and that after storage (for example, after storage at 80° C. for 6 days) is preferably from 0 mPa·s to 1.0 mPa·s, more preferably from 0 mPa·s to 0.5 mPa.

From the viewpoint of further suppressing a decrease of the storage stability of the aqueous ink, the volume-average particle diameter of the pigment dispersed in the aqueous pigment dispersion composition difference between the volume-average particle diameter immediately after preparation (before storage) of the aqueous ink and that after storage (for example, after storage at 80° C. for 6 days) is preferably from 0 nm to 10 nm, more preferably from 0 nm to 5 nm.

Each of the measuring methods of the pH, the conductivity, and the viscosity of the aqueous ink, and the volume-average particle diameter of the pigment in the aqueous ink is the same as each of the measuring methods of the pH, the conductivity, and the viscosity of the aqueous pigment dispersion composition, and the volume-average particle diameter of the pigment in the aqueous pigment dispersion composition.

The surface tension of the aqueous ink is, for example, in a range of 20 mN/m to 50 mN/m, preferably 25 mN/m to 45 mN/m.

Here, the surface tension is a value obtained by measuring under an environment of 23° C. and 55% RH using a Wilhelmy Plate tensiometer (manufactured by Kyowa Interface Science Co., Ltd.)

(Recording Apparatus/Recording Method)

The recording apparatus according to the exemplary embodiment is a recording apparatus provided with ejection heads for ejecting the aqueous ink according to the exemplary embodiment onto a recording medium. The recording apparatus according to the exemplary embodiment realizes a recoding method including an ejection step for ejecting the aqueous ink according to the exemplary embodiment onto a recording medium.

The recording apparatus according to the exemplary embodiment may be provided with an ink cartridge which accommodates the aqueous ink according to the exemplary embodiment and is made into a cartridge so as to be detachable from the recording apparatus.

Hereinafter, a description regarding an example of the recording apparatus and the recording method according to the exemplary embodiment will be provided referring to a FIGURE.

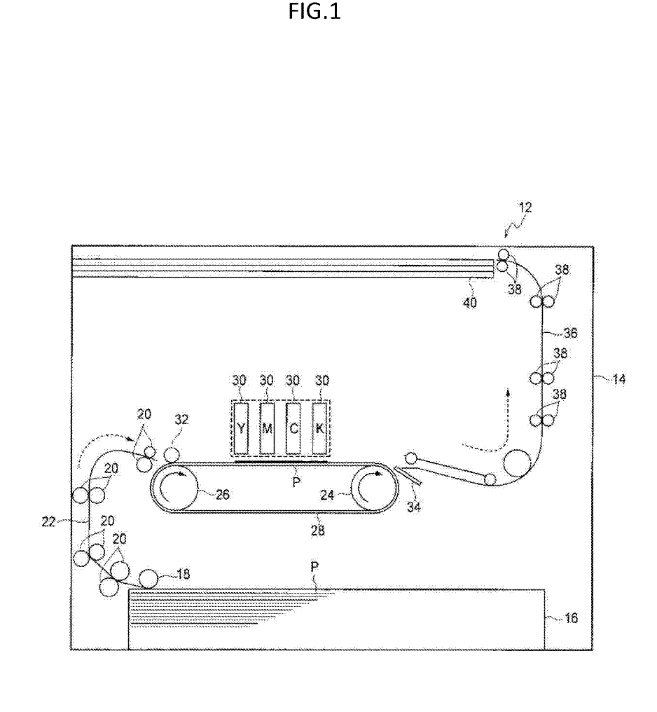

FIG. 1 is a schematic diagram illustrating the configuration of the recording apparatus according to the exemplary embodiment.

As shown in FIG. 1, for example, the recording apparatus 12 according to the exemplary embodiment is provided with a paper feed container 16 at the lower portion in a casing 14, and has a mechanism in which a take-out roll 18 takes out a paper P (an example of a recording medium) stacked in the paper feed container 16 one by one. The paper P taken out is transported with a plurality of transporting roller pairs 20 constituting a transport path 22.

An endless transport belt 28 supported while being applied with a tension to a driving roll 24 and a driven roll 26 is disposed above the paper feed container 16. Ejection heads 30 (an example of an ejecting device) are disposed above the transport belt 28 and face a flat portion of the transport belt 28. The region where the ejection heads 30 face the flat portion of the transport belt 28 is the ejection region where ink droplets are ejected from the ejection heads 30 onto the paper P. The paper P transported by the pairs of transporting rollers 20 is held by the transport belt 28 and arrives at this ejection region in a state of facing the ejection heads 30. Then, the ejection heads 30 eject droplets of ink in accordance with the image information, and the droplets of ink adhere to the surface of the paper P.

The ejection heads 30 are a plurality of ejection heads for ejecting ink droplets with inkjet style, and any known ejection may be employed as the ejection heads. For example, the ejection heads 30 may be so-called thermal ejection heads, which eject ink droplets from a plurality of nozzles with heat, or so-called piezoelectric ejection heads, which eject droplets of ink with pressure.

Examples of the ejection heads 30 include an ejection head having an elongated shape which has an effective recording region (region above which nozzles for ejecting ink are located) and having a width (length in the direction crossing the transporting direction (for example, perpendicular direction)) greater than or equal to that of the paper P.

Examples of the arrangement configuration of the ejection heads 30 include an arrangement configuration in which four ejection heads corresponding to four colors of yellow (Y), magenta (M), cyan (C), and black (K) are arranged in an array along the transport direction, an arrangement configuration in which one ejection head 30 corresponding to black (K) is arranged, and an arrangement configuration in which four or more ejection heads 30 corresponding to four or more colors with other intermediate color(s) added are arranged corresponding to the purpose.

A charging roll 32 is disposed upstream of the ejection heads 30 (upstream in the transporting direction of the paper P). The charging roll 32 is driven while sandwiching the transport belt 28 and the paper P between the charging roll 32 and the driven roll 26 to generate a potential difference between the charging roll 32 and the driven roll 26 which is grounded and charge the paper P, thereby electrostatically attaching the paper P onto the transport belt 28.

A peeling plate 34 is disposed downstream of the ejection heads 30 (downstream in the transporting direction of the paper P), and peels off the paper P from the transport belt 28. The peeled-off paper P is transported by a plurality of output roller pairs 38 constituting an output path 36 downstream of the peeling plate 34 (downstream in the transporting direction of the paper P), and is output to an output paper container 40 provided on the upper portion of the casing 14.

The recording apparatus 12 illustrated in FIG. 1 employs a method of directly ejecting droplets of ink onto the surface of the paper P by the ejection heads 30, but the method employed in printing is not limited to this. For example, a method of ejecting ink droplets onto an intermediate transfer body and transferring the ink droplets onto the paper P may be employed.

In the description regarding the recording apparatus 12, a method of ejecting an aqueous ink onto a sheet-like recording medium of a desired size and recording an image has been described, but a method of ejecting an aqueous ink onto a roll-shaped recording medium (so-called interleaf paper) and recording an image may also be employed.

In the description regarding the recording apparatus 12, a recording apparatus not provided with a drying device has been described, but the recording apparatus may also be a recording apparatus provided with a drying apparatus for drying the ejected aqueous ink onto the recording medium.

The exemplary embodiment shall not to be construed as limitation and can be realized in any form within the scope that satisfies the requirements of the present invention.

### EXAMPLES

Although specific descriptions regarding examples of the present invention are described below, the present invention is not limited to the following specific examples. In the following description, “parts” and “%” are all in terms of mass unless otherwise specified.

### [Example 1] (Synthesis of Pigment Dispersant 1)

200 parts of methyl ethyl ketone is fed into a reaction vessel and heated to 78° C. under nitrogen flow. 90 parts of β-carboxyethyl acrylate (CEA: SIPOMER β-CEA J; manufactured by Solvay Nikka Co., Ltd.), 240 parts of ethyl methacrylate (EMA), 270 parts of polystyrene macromonomer (AS-6, manufactured by Toagosei Co., Ltd.), 200 parts of methyl ethyl ketone, and 12 parts of V-601 (polymerization initiator, manufactured by Wako Pure Chemical Industries, Ltd.) are dropped over 3 hours to the reaction vessel, and further reacted at 80° C. for 3 hours. Methyl ethyl ketone is distilled off under reduced pressure to obtain Pigment Dispersant 1 in a form of a white powder. The mass-based ratio CEA/EMA/AS-6 of CEA, EMA and AS-6 is set to 15/40/45.

The acid value of Pigment Dispersant 1 is found to be 51 mgKOH/g, and the Mw is found to be 43,000.

(Synthesis of Pigment Dispersant 2)

Pigment Dispersant 2 is synthesized in the same manner as in the synthesis of Pigment Dispersant 1, except that the mass-based ratio CEA/EMA/AS-6 of CEA, EMA and AS-6 is set to 15/20/65.

The acid value of Pigment Dispersant 2 is found to be 51 mgKOH/g, and the Mw is found to be 51,000.

(Synthesis of Pigment Dispersant 3)

Using butyl acrylate (BA) instead of EMA, Pigment Dispersant 3 is synthesized in the same manner as in the synthesis of Pigment Dispersant 1, except that the mass-based ratio CEA/BA/AS-6 of CEA, BA and AS-6 is set to 15/50/35.

The acid value of Pigment Dispersant 3 is found to be 51 mgKOH/g, and the Mw is found to be 38,000.

(Synthesis of Pigment Dispersant 4)

Pigment Dispersant 4 is synthesized in the same manner as in the synthesis of Pigment Dispersant 1, except that the mass-based ratio CEA/EMA/AS-6 of CEA, EMA and AS-6 is set to 30/25/45.

The acid value of Pigment Dispersant 4 is found to be 103 mgKOH/g, and the

Mw is found to be 43,000.

(Synthesis of Pigment Dispersant 5) Using 2-methacryloyloxyethyl succinic acid (SEMA) instead of CEA, Pigment Dispersant 5 is synthesized in the same manner as in the synthesis of Pigment Dispersant 1, except that the mass-based ratio SEMA/EMA/AS-6 of SEMA, EMA and AS-6 is set to 20/35/45.

The acid value of Pigment Dispersant 5 is found to be 49 mgKOH/g, and the Mw is found to be 41,000.

(Synthesis of Pigment Dispersant 6)

Except for using AN-6S manufactured by Toagosei Co., Ltd. instead of AS-6, Pigment Dispersant 6 is synthesized in the same manner as in the synthesis of Pigment Dispersant 1.

The acid value of Pigment Dispersant 6 is found to be 51 mgKOH/g, and the Mw is found to be 55,000.

(Synthesis of Comparative Pigment Dispersant 1)

Using methacrylic acid (MAA) instead of CEA and styrene (St) instead of AS-6, Comparative Pigment Dispersant 1 is synthesized in the same manner as in the synthesis of Pigment Dispersant 1, except that the mass-based ratio MMA/EMA/St of MMA, EMA and St is set to 15/40/45.

The acid value of Comparative Pigment Dispersant 1 is found to be 100 mgKOH/g, and the Mw is found to be 33,000.

(Synthesis of Comparative Pigment Dispersant 2)

Using methacrylic acid (MAA) instead of CEA, Comparative Pigment Dispersant 2 is synthesized in the same manner as in the synthesis of Pigment Dispersant 1, except that the mass-based ratio MMA/EMA/AS-6 of MMA, EMA and AS-6 is set to 8/47/45.

The acid value of Comparative Pigment Dispersant 2 is found to be 52 mgKOH/g, and the Mw is found to be 46,000.

### Examples 1 to 9 and Comparative Examples 1 to 4

(Preparation of Aqueous Pigment Dispersion Composition and Aqueous Ink)

3.0 parts of each of the pigments, 0.9 parts of each of the pigment dispersants, 25% sodium hydroxide aqueous solution in an amount in which the carboxy group contained in each pigment dispersant is equal to the molar amount of sodium hydroxide, and water are mixed, and dispersed for 60 minutes with an ultrasonic disperser to obtain an aqueous pigment dispersion composition having a pigment concentration of 15%. Used pigments and pigment dispersants are as listed in Table 1 or 2. In Comparative Example 4, 0.3 parts of a surfactant (Tayca Power BN 2060 (product name), manufactured by Tayca Corporation) is added instead of a pigment dispersant.

To the obtained aqueous pigment dispersion composition, the water-soluble organic solvent listed in Table 1 or 2 is added in the amount listed in Table 1 or 2, and water is added thereto so that the pigment concentration became 5% to obtain an aqueous ink.

<Evaluation>

An aqueous solution of 3% of nitric acid or 10% of sodium hydroxide is added to the obtained aqueous ink to adjust the pH thereof to 7.5 and 9.5. The volume-average particle diameter of the pigment in the aqueous ink before the pH adjustment and the volume-average particle diameter of the pigment in the aqueous ink are measured after 7 days from the pH adjustment at 30° C. are measured using a dynamic light scattering particle size distribution measuring apparatus (LB-500 (manufactured by Horiba Ltd.)). The dispersion stability is evaluated based on presence or absence of sediment by visual observation before and after the pH adjustment and the change rate of the volume-average particle diameter, in accordance with the following criteria. The obtained results are listed in Table 1 or 2.

—Evaluation Criteria—

A: Change rate of the volume-average particle diameter is less than 10% with no sediment

B: Change rate of the volume-average particle diameter is 10% or more with no sediment

C: Sediment is confirmed.

TABLE 1

| | Examples | | | | | | |
|---|---|---|---|---|---|---|---|
| | Example 1 | Example 2 | Example 3 | Example 4 | Example 5 | Example 6 | Example 7 |
| Dispersant | Dispersant 1 | Dispersant 2 | Dispersant 3 | Dispersant 4 | Dispersant 1 | Dispersant 1 | Dispersant 1 |
| Pigment | PR122 | PR122 | PR122 | PR122 | PR122 | PR122 | PB15:3 |
| Organic solvent | PG | DPM | EG | DPM/PG | EG | PG | EG |
| | 40% | 40% | 40% | 10%/30% | 50% | 40% | 40% |
| Particle | A | A | A | A | B | A | A |
| diameter change | | | | | | | |
| pH 7.5 | | | | | | | |
| Particle | A | A | A | A | A | A | A |
| diameter change | | | | | | | |
| pH 9.5 | | | | | | | |

TABLE 2

| | Examples | | | | | |
|---|---|---|---|---|---|---|
| | | | Comparative | Comparative | Comparative | Comparative |
| | Example 8 | Example 9 | Example 1 | Example 2 | Example 3 | Example 4 |
| Dispersant | Dispersant 1 | Dispersant 5 | Comparative | Comparative | Comparative | Surfactant |
| | | | Dispersant 1 | Dispersant 1 | Dispersant 2 | |
| Pigment | PY74 | PR122 | PR122 | PR122 | PR122 | PR122 |
| Organic solvent | PG | PG | — | PG | EG | PG |
| | 40% | 40% | 0 | 40% | 40% | 40% |
| Particle | A | A | C | C | C | C |
| diameter change | | | | | | |
| pH 7.5 | | | | | | |
| Particle | A | A | A | B | A | C |
| diameter change | | | | | | |
| pH 9.5 | | | | | | |

In Tables 1 and 2, meanings of the abbreviations are as follows.

PG: propylene glycol

EG: ethylene glycol

DPM: dipropylene glycol monomethyl ether

PR122: C. I. Pigment Red-122

PB15:3: C. I. Pigment Blue-15:3

PY74: C. I. Pigment Yellow-74

(Synthesis of Pigment Dispersant D-1)

200 parts of methyl ethyl ketone is fed into a reaction vessel and heated to 78° C. under nitrogen flow. A mixture of 90 parts of β-carboxyethyl acrylate (β-CEA: SIPOMER β-CEA J; manufactured by Solvay Nikka Co., Ltd.), 150 parts of ethyl methacrylate (EMA), 360 parts of benzyl methacrylate (BzMA), 200 parts of methyl ethyl ketone, and 12 parts of V-601 (polymerization initiator, manufactured by Wako Pure Chemical Industries, Ltd.) are dropped over 3 hours to the reaction vessel, and further reacted at 80° C. for 3 hours. Methyl ethyl ketone is distilled off under reduced pressure to obtain Pigment Dispersant D-1 in a form of a white powder. The mass-based ratio BzMA/β-CEA/EMA of BzMA, β-CEA, and EMA is 60/15/25.

The acid value of Pigment Dispersant D-1 is found to be 51 mgKOH/g, and the weight-average molecular weight is found to be 41,000.

(Synthesis of Pigment Dispersant D-2)

Pigment Dispersant D-2 is synthesized in the same manner as in Example 1, except that the mass-based ratio BzMA/β-CEA/EMA of BzMA, β-CEA, and EMA is set to 60/11/29.

The acid value of Pigment Dispersant D-2 is found to be 38 mgKOH/g, and the weight-average molecular weight is found to be 39,000.

(Synthesis of Pigment Dispersant D-3)

Pigment Dispersant D-3 is synthesized in the same manner as in Example 1, except that the mass-based ratio BzMA/β-CEA/EMA of BzMA, β-CEA, and EMA is set to 60/27/13.

The acid value of Pigment Dispersant D-3 is found to be 92 mgKOH/g, and the weight-average molecular weight is found to be 44,000.

(Synthesis of Pigment Dispersant D-4)

Using phenoxyethyl methacrylate (POEMA) instead of BzMA, Pigment Dispersant D-4 is synthesized in the same manner as in Example 1, except that the mass-based ratio POEMA/β-CEA/EMA of POEMA, β-CEA, and EMA is set to 60/15/25.

The acid value of Pigment Dispersant D-4 is found to be 51 mgKOH/g, and the weight-average molecular weight is found to be 40,000.

(Synthesis of Pigment Dispersant D-5)

Using benzyl acrylate (BzA) instead of BzMA, Pigment Dispersant D-5 is synthesized in the same manner as in Example 1, except that the mass-based ratio BzA/β-CEA/EMA of BzA, β-CEA, and EMA is set to 60/15/25.

The acid value of Pigment Dispersant D-5 is found to be 51 mgKOH/g, and the weight-average molecular weight is found to be 40,000.

(Synthesis of Pigment Dispersant D-6)

Using 2-methacryloyloxyethyl succinic acid (SEMA) instead of β-CEA, Pigment Dispersant D-6 is synthesized in the same manner as in Example 1, except that the mass-based ratio BzMA/SEMA/EMA of BzMA, SEMA, and EMA is set to 60/20/20.

The acid value of Pigment Dispersant D-6 is found to be 49 mgKOH/g, and the weight-average molecular weight is found to be 39,000.

(Synthesis of Pigment Dispersant D-7)

Using cyclohexyl methacrylate (CHMA) instead of EMA, Pigment Dispersant D-7 is synthesized in the same manner as in Example 1, except that the mass-based ratio BzMA/β-CEA/CHMA of BzMA, β-CEA, and CHMA is set to 60/15/25.

The acid value of Pigment Dispersant D-7 is found to be 51 mgKOH/g, and the weight-average molecular weight is found to be 40,000.

(Synthesis of Pigment Dispersant D-8)

Pigment Dispersant D-8 is synthesized in the same manner as in Example 1, except that the mass-based ratio BzMA/β-CEA/EMA of BzMA, β-CEA, and EMA is set to 43/15/42.

The acid value of Pigment Dispersant D-8 is found to be 51 mgKOH/g, and the weight-average molecular weight is found to be 39,000.

(Synthesis of Pigment Dispersant D-9)

Pigment Dispersant D-9 is synthesized in the same manner as in Example 1, except that the mass-based ratio BzMA/β-CEA/EMA of BzMA, β-CEA, and EMA is set to 73/15/12.

The acid value of Pigment Dispersant D-9 is found to be 51 mgKOH/g, and the weight-average molecular weight is found to be 42,000.

(Synthesis of Pigment Dispersant D-10)

Pigment Dispersant D-10 is synthesized in the same manner as in Example 1, except that the mass-based ratio BzMA/β-CEA/EMA of BzMA, β-CEA, and EMA is set to 32/15/53.

The acid value of Pigment Dispersant D-10 is found to be 51 mgKOH/g, and the weight-average molecular weight is found to be 40,000.

(Synthesis of Pigment Dispersant D-11)

Using BzA instead of BzMA, Pigment Dispersant D-11 is synthesized in the same manner as in Example 1, except that the mass-based ratio BzA/β-CEA/EMA of BzA, β-CEA, and EMA is set to 81/15/4.

The acid value of Pigment Dispersant D-11 is found to be 51 mgKOH/g, and the weight-average molecular weight is found to be 39,000.

(Synthesis of Pigment Dispersant D-12)

Using methacrylic acid (MAA) instead of β-CEA, Pigment Dispersant D-12 is synthesized in the same manner as in Example 1, except that the mass-based ratio BzMA/MAA/EMA of BzMA, MAA, and EMA is set to 60/8/32.

The acid value of Pigment Dispersant D-12 is found to be 52 mgKOH/g, and the weight-average molecular weight is found to be 42,000.

(Synthesis of Pigment Dispersant D-13)

Using 2-acrylamide-2-methylpropanesulfonic acid (AMPS) instead of β-CEA, Pigment Dispersant D-13 is synthesized in the same manner as in Example 1, except that the mass-based ratio BzMA/AMPS/EMA of BzMA, AMPS, and EMA is set to 60/21/19.

The acid value of Pigment Dispersant D-13 is found to be 57 mgKOH/g, and the weight-average molecular weight is found to be 40,000.

(Synthesis of Pigment Dispersant D-14)

Using styrene (St) instead of BzMA, Pigment Dispersant D-14 is synthesized in the same manner as in Example 1, except that the mass-based ratio St/β-CEA/EMA of St, β-CEA, and EMA is set to 35/15/50.

The acid value of Pigment Dispersant D-14 is found to be 51 mgKOH/g, and the weight-average molecular weight is found to be 33,000.

(Synthesis of Pigment Dispersant D-15)

Pigment Dispersant D-15 is synthesized in the same manner as in Example 1, except that the mass-based ratio BzMA/β-CEA/EMA of BzMA, β-CEA, and EMA is set to 60/6/34.

The acid value of Pigment Dispersant D-15 is found to be 21 mgKOH/g, and the weight-average molecular weight is found to be 36,000.

(Synthesis of Pigment Dispersant D-16)

Pigment Dispersant D-16 is synthesized in the same manner as in Example 1, except that the mass-based ratio BzMA/β-CEA/EMA of BzMA, β-CEA, and EMA is set to 60/32/8.

The acid value of Pigment Dispersant D-16 is found to be 110 mgKOH/g, and the weight-average molecular weight is found to be 46,000.

The acid values of the obtained pigment dispersant D-1 to D-16 and the contents of aromatic ring therein are summarized in Table 1.

### [Examples 10 to 23 and Comparative Examples 5 to 9] (Preparation of Aqueous Pigment Dispersion Composition and Aqueous Ink)

3.0 parts of each of the pigments and 0.9 parts of each of the pigment dispersants listed in Table 3, 25% sodium hydroxide aqueous solution in an amount in which the carboxy group contained in each pigment dispersant is equal to the molar amount of sodium hydroxide, 0.9 parts of methyl ethyl ketone, and water are mixed. The mixture is fed in a beads mill disperser together with 100 parts of 0.1 mm zirconia beads and dispersed for 6 hours. The zirconia beads are removed by filtering the obtained dispersion, and the mixture is concentrated under reduced pressure using an evaporator to remove methyl ethyl ketone and concentrated to a pigment concentration of 15% to obtain an aqueous pigment dispersion composition.

To one part of the obtained aqueous pigment dispersion composition, 0.8 parts of propylene glycol, 0.2 parts of tripropylene glycol, 0.05 parts of Surfynol 440 (manufactured by Nissin Chemical Industry Co., Ltd.), and pure water are added so that the pigment concentration became 5.0% to obtain an aqueous ink.

<Evaluation> (Dispersion Stability)

While stirring the aqueous ink, 3% nitric acid is added to adjust the pH to 7.5, and the viscosity at 23° C. (viscosity after the pH adjustment) of the aqueous ink kept for one day at 23° C. is measured. Next, after adding the same amount of pure water as the amount of 3% nitric acid to the original aqueous ink, the viscosity at 23° C. (viscosity before the pH adjustment) is measured. From the obtained result, the viscosity change rate [(difference between pH after adjustment and viscosity before pH adjustment)/viscosity before pH adjustment]×100] (%) is calculated and evaluated based on the following criteria.

—Evaluation Criteria—

G1: viscosity change rate is 2% or less (excellent dispersion stability)

G2: viscosity change rate is more than 2% and 5% or less (good dispersion stability)

G3: viscosity change rate more than 5% and 10% or less (slight change in viscosity, but practically available)

G4: viscosity change rate is more than 10% and 15% or less (large viscosity change and poor dispersion stability)

G5: viscosity change rate is more than 15% (very large viscosity change)

(Water Resistance)

The obtained aqueous ink is coated on an OS coated paper W (127 g/m², manufactured by Fuji Xerox Co., Ltd.) using a bar coater (No. 7) to form a solid image and heated on a hot plate at 60° C. for 3 minutes. The obtained solid image is rubbed 5 times reciprocatingly with Bemcot (manufactured by Ozu Sangyo Co., Ltd.) moistened with water, the image portion and Bemcot are visually observed and evaluated based on the following criteria. G1 and G2 are the ranges practically acceptable.
G1: no solid image change. no shift to Bemcot. excellent in water resistance.
G2: slight concentration change in solid image or slight color transfer to Bemcot is observed. good water resistance.
G3: peeling of solid image with large concentration change is observed. poor water resistance.

TABLE 3

| | | | | | | | | | Water |
|---|---|---|---|---|---|---|---|---|---|
| | Pigment | Structural | Structural | Structural | | | | Dispersion | resistance of |
| | dispersant | unit A | unit B | unit C | Acid value | Aromatic Ring content | Pigment | stability | image |
| Example 10 | D-1 | BzMA | β-CEA | EMA | 51 | 26.2 | PB15:3 | G1 | G2 |
| Example 11 | D-2 | BzMA | β-CEA | EMA | 38 | 26.2 | PB15:3 | G3 | G1 |
| Example 12 | D-3 | BzMA | β-CEA | EMA | 92 | 26.2 | PB15:3 | G2 | G3 |
| Example 13 | D-4 | POEMA | β-CEA | EMA | 51 | 22.4 | PB15:3 | G1 | G2 |
| Example 14 | D-5 | BzA | β-CEA | EMA | 51 | 28.5 | PB15:3 | G1 | G2 |
| Example 15 | D-6 | BzMA | SEMA | EMA | 49 | 26.2 | PB15:3 | G2 | G2 |
| Example 16 | D-7 | BzMA | β-CEA | CHMA | 51 | 26.2 | PB15:3 | G1 | G2 |
| Example 17 | D-8 | BzMA | β-CEA | EMA | 51 | 18.8 | PB15:3 | G2 | G2 |
| Example 18 | D-9 | BzMA | β-CEA | EMA | 51 | 31.9 | PB15:3 | G2 | G1 |
| Example 19 | D-10 | BzMA | β-CEA | EMA | 51 | 14.0 | PB15:3 | G3 | G2 |
| Example 20 | D-11 | BzA | β-CEA | EMA | 51 | 38.5 | PB15:3 | G3 | G2 |
| Example 21 | D-1 | BzMA | β-CEA | EMA | 51 | 26.2 | PR122 | G3 | G2 |
| Example 22 | D-1 | BzMA | β-CEA | EMA | 51 | 26.2 | PY155 | G1 | G2 |
| Example 23 | D-1 | BzMA | β-CEA | EMA | 51 | 26.2 | CB | G2 | G2 |
| Comparative | D-12 | BzMA | MAA | EMA | 52 | 26.2 | PB15:3 | G5 | G2 |
| Example 5 | | | | | | | | | |
| Comparative | D-13 | BzMA | AMPS | EMA | 57 | 26.2 | PB15:3 | G2 | G3 |
| Example 6 | | | | | | | | | |
| Comparative | D-14 | St | β-CEA | EMA | 51 | 25.9 | PB15:3 | G4 | G3 |
| Example 7 | | | | | | | | | |
| Comparative | D-15 | BzMA | β-CEA | EMA | 21 | 26.2 | PB15:3 | G5 | G2 |
| Example 8 | | | | | | | | | |
| Comparative | D-16 | BzMA | β-CEA | EMA | 110 | 26.2 | PB15:3 | G4 | G3 |
| Example 9 | | | | | | | | | |

In Table 3, the structural unit A means a monomer from which “structural unit having an aromatic group from the main chain skeleton with a linking group interposed therebetween” is originated, and the structural unit B is a monomer from which “structural unit represented by the General Formula (1)” is originated, and the structural unit C means other monomers.

In Table 3, meanings of the abbreviations are as follows.

PB15:3 C. I. Pigment Blue-15:3 (FASTOGEN Blue TGR-SD, manufactured by DIC Corporation)

PR122 C. I. Pigment Red 122 (FASTOGEN Super Magenta RGT, manufactured by DIC Corporation)

PY155 C. I. Pigment Yellow 155 (Ink Jet Yellow 4GC, manufactured by Clariant Corporation)

CB carbon black (manufactured by Cabot Corporation, BP880)

In Table 3, the unit of “acid value” is “mgKOH/g” and the unit of aromatic ring content is “mass %”.

What is claimed is:

1. A pigment dispersant comprising:
a polymer having a structural unit represented by General Formula (1); and
a structural unit derived from a polystyrene macromonomer, 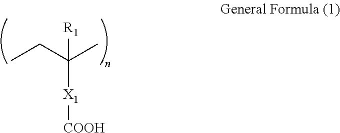
wherein, n represents a positive integer, R₁ represents a hydrogen atom or a methyl group, and X₁ represents a divalent linking group except a single bond.

2. The pigment dispersant according to claim 1,
wherein the structural unit represented by General Formula (1) includes a structural unit derived from a (meth)acrylate compound.

3. The pigment dispersant according to claim 1,
wherein the structural unit represented by formula (1) includes a structural unit derived from a (meth)acrylic acid multimer.

4. The pigment dispersant according to claim 1,
wherein the divalent linking group of General Formula (1) is selected from a group consisting of: a linear, branched, or a cyclic alkylene group; an aralkylene group; an arylene group; a heterocyclic group; —CO—; —O—; —NH—; or —S—; and combinations thereof.

5. The pigment dispersant according to claim 1,
wherein the number of atoms interposed between a carbon atom bonded to R₁ and a carboxy group is from 1 to 16, and the atom is at least one selected from the group consisting of a carbon atom, an oxygen atom, a nitrogen atom, a sulfur atom, a silicon atom, and a phosphorus atom.

6. The pigment dispersant according to claim 1,
wherein the number-average molecular weight of the polystyrene macromonomer is from 1,000 to 10,000.

7. The pigment dispersant according to claim 1,
wherein the percentage of the structural represented by General Formula (1) is from 5% by weight to 50% by weight.

8. The pigment dispersant according to claim 1,
wherein a weight of the structural unit derived from a polystyrene macromonomer is from 10% by weight to 80% by weight.

9. An aqueous pigment dispersion composition, comprising:
a pigment;
water; and
the pigment dispersant according to claim 1.

10. The aqueous pigment dispersion composition according to claim 9, further comprising:
a water-soluble organic solvent

11. The aqueous pigment dispersion composition according to claim 10,
wherein the content of the water-soluble organic solvent is from 1% by weight to 60% by weight.

12. The aqueous pigment dispersion composition according to claim 9,
wherein the pigment includes a quinacridone pigment.

13. An aqueous ink, comprising:
a pigment;
water;
a water-soluble organic solvent; and
the pigment dispersant according to claim 1.

14. The aqueous ink according to claim 13,
wherein the content of the water-soluble organic solvent is from 1% by weight to 60% by weight.

15. The aqueous ink according to claim 13,
wherein the pigment includes a quinacridone pigment.

16. The aqueous ink according to claim 13,
wherein the content of the pigment is from 1% by weight to 25% by weight with respect to the entire amount of the aqueous ink.

17. The aqueous ink according to claim 13, further comprising a surfactant having Hydrophile-Lipophile Barance of 14 or less.

18. The aqueous ink according to claim 13, having a conductivity in a range of 0.01 S/m to 0.5 S/m.

19. The aqueous ink according to claim 13, having a viscosity in a range of 1.5 mPa·s to 30 mPa·s.

20. The aqueous ink according to claim 13, wherein
a difference between a volume-average particle diameter of the pigment dispersed in the aqueous pigment dispersion composition before storage at 80° C. for 6 days of the and a volume-average particle diameter of the pigment dispersed in the aqueous pigment dispersion composition after the storage is 0 nm or more and 10 nm or less.
